(19) United States
(12) Patent Application Publication
(10) Pub. No.: US 2003/0079217 A1
(43) Pub. Date: Apr. 24, 2003

(54) Method for subserving preloaded programs

(76) Inventor: Chern-Muh Wang, Taipei (TW)

Correspondence Address: BIRCH STEWART KOLASCH & BIRCH, PO BOX 747, FALLS CHURCH, VA, 22040-0747, US

(21) Appl. No.: 09/982,013

(22) Filed: Oct. 19, 2001

(51) Int. Cl. G06F 9/44; G06F 9/445

(52) U.S. Cl. 717/175; 717/169

(57) ABSTRACT

A method for subserving preloaded programs, disclosed by the invention, is used to generate a planning file needed by the preloaded programs. The method involves finding a file that contains installation flow data of the preloaded software programs, increasing their sequential numbers, and storing the installation flow data in a corresponding location of the planning file. Therefore, the manual input method is replaced, and the problem of wasted storage space is solved, while the storage space is efficiently maintained.

### BACKGROUND OF THE INVENTION

### Field of the Invention

The present invention relates to a software method executable on computers, and more particularly, to a method for subserving preloaded programs.

### Related Art

When delivering computers to clients, most vendors only install operating systems or necessary drivers and store them in the computers. The preference of the users is ignored. Some products, such as Installer of Compaq, can store a lot of software in the computers. After the users get the computers, they can decide whether to install all software on the computers (the users don't need to know serial numbers or passwords). This is called “preloading”. For users, this is a very convenient method. The users don't need to change software CD-ROMs to install programs, and mistakes caused by such manual operations can also be avoided.

In contrast, for manufacturers or suppliers, this is an additional burden. Common preloaded programs must accommodate a planning file to be executed so that the preloaded programs can be installed according to the contents of the planning file. For instance, a preloaded program, Installer of Compaq, must accommodate a planning file, comp.ini, so that users can choose what to install.

While executing, the planning file comp.ini must be inputted manually. Because the planning file records correspond to preloaded software, computers with different software have different planning files. Different brands, languages of operating systems, software versions, or users' requirements have different planning files. Storage space is thus wasted. Furthermore, manually inputting is difficult to process.

### SUMMARY OF THE INVENTION

It is therefore a primary objective of the invention to provide a method for subserving preloaded programs to solve the above mentioned problems. According to the invention, the method for subserving preloaded programs is used to generate a planning file needed by the preloaded programs. The method comprises: (1) searching a file which contains installation flow data of the preloaded software; (2) duplicating the installation flow data of the preloaded software; (3) increasing the number of the preloaded software; and (4) storing the installation flow data of the preloaded software in a corresponding location of the planning file.

An advantage of the invention is that the planning file needed by the preloaded programs doesn't require a manual input method. The problem of wasting storage space can be effectively resolved.

Further scope of applicability of the invention will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a flow diagram of the steps of the invention.

FIG. 2A˜2C are diagrams of the preferred embodiment of the invention.

### DETAILED DESCRIPTION OF THE INVENTION

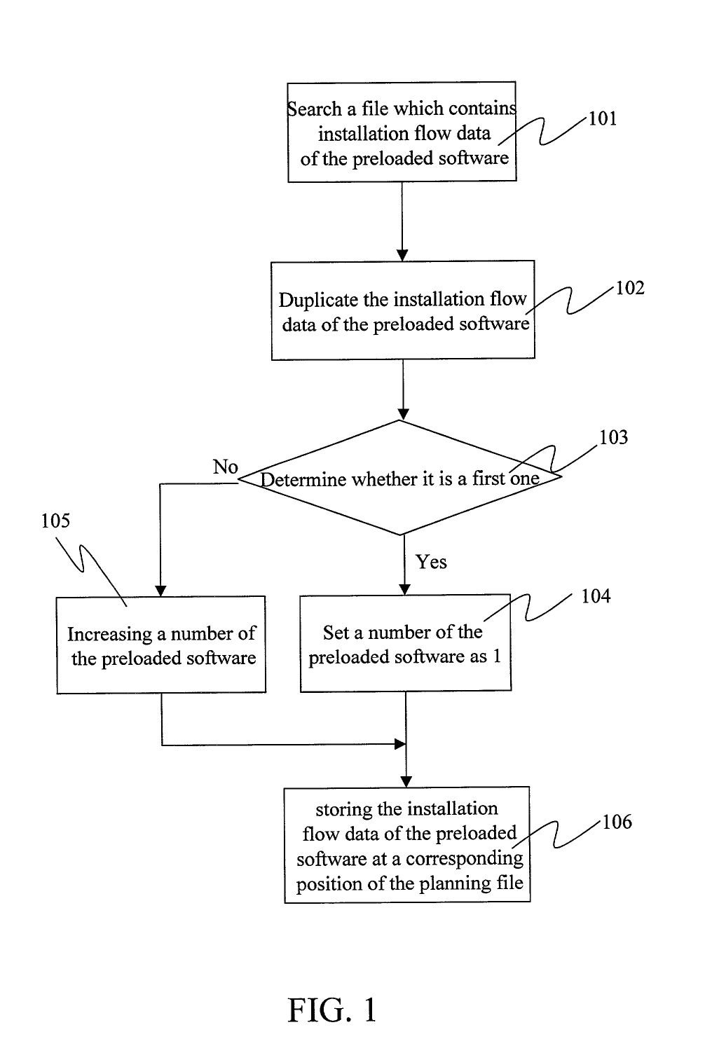

Please refer to FIG. 1. First, serach a file that contains installation flow data of the preloaded software (step 101), which is one of the software data in the preloaded program. In general, it is recorded in a file with the .ini extension. Next, duplicate the installation flow data of the preloaded software (step 102). At this time, determine whether it is the first preloaded software program (step 103). If it is, set its number as 1 (step 104); if it is not, increase its number sequentially according to the previous preloaded software programs (step 105). Then, store the installation flow data of the preloaded software in a corresponding location of the planning file (step 106). Perform these steps repeatedly until the installation flow data of all preloaded software is stored and the planning file is completed.

A preloaded program, Installer of Compaq, is taken as an example. For users using Installer, a planning file comp.ini is necessary. The suppliers or manufacturers utilize a program called File Based Installer (FBI), to generate it. File Based Installer reads files with a .bto extension for each preloaded software program to generate the planning file, comp.ini, according to data stored in Info.bom.

Here, the .bto files of each preloaded software program and the subserving preloaded program 20 of the invention are executed, so that File Based Installer calls the subserving preloaded program 20 to generate and complete the planning file 30, comp.ini, automatically while executing the .bto files of each preloaded software program.

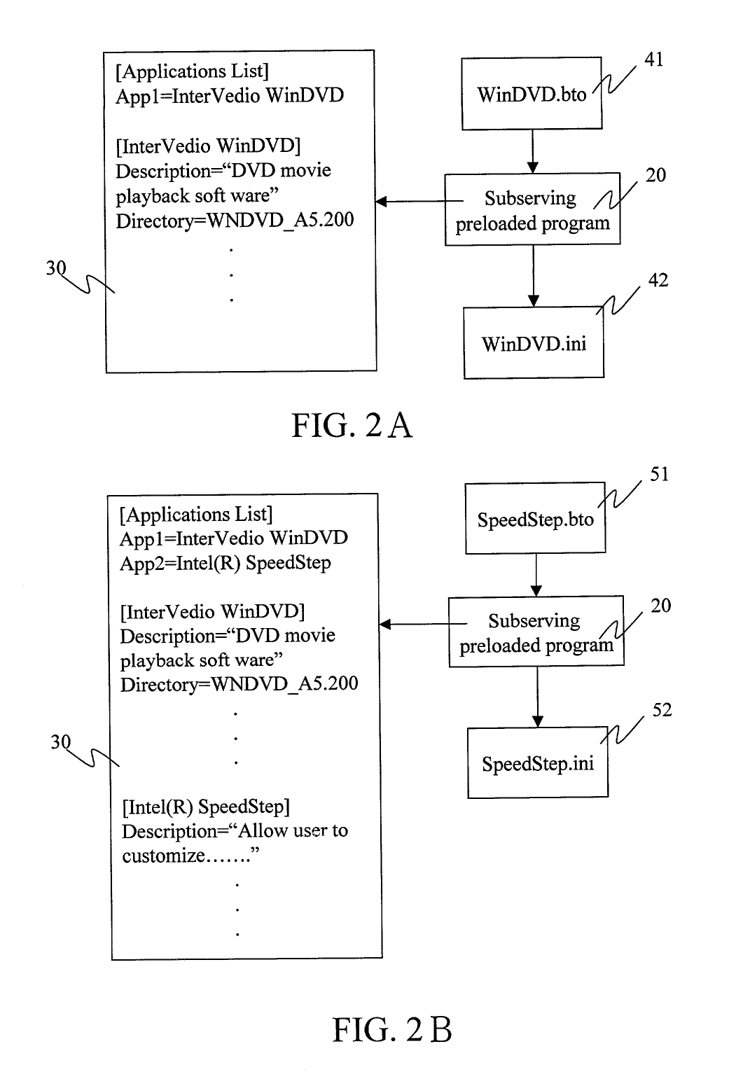

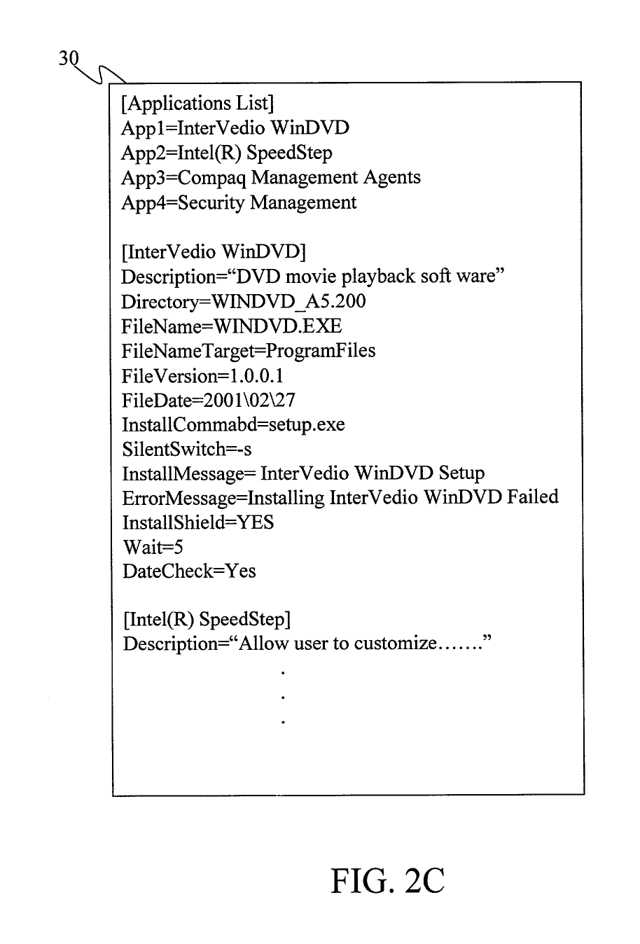

As shown in FIG. 2A, when executing WinDVD.bto 41, the subserving preloaded program 20 is called to search WinDVD.ini 42. Next, WinDVD.ini 42 duplicates the flow data needed in installing WinDVD. Because it is determined to be the first preloaded software program, its number is set 1 (i.e. App1) in the planning file 30 shown in FIG. 2A. The number is stored at the starting position of the file, then relative installation flow data is stored continuously.

Please refer to FIG. 2B. The .bto file of the second preloaded software is read, i.e. SpeedStep.bto 51. Similarly, the subserving preloaded program 20 is initiated to search SpeedStep.ini 52. Next, SpeedStep.ini 52 duplicates the flow data needed for installing SpeedStep. Because it is the second preloaded program, the number is increased to App2, as shown in FIG. 2B. Likewise, the software name and the number are stored at the starting position of the planning file 30, then the installation flow data is stored after the installation flow data of the previous preloaded software program. After this process is repeated for each preloaded software program, the planning file is completed (as shown in FIG. 2C).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for subserving preloaded programs used to subserve to generate a planning file needed by the preloaded programs; the method comprises:
searching a file which contains installation flow data of the preloaded software;
duplicating the installation flow data of the preloaded software;
increasing a number of the preloaded software; and
storing the installation flow data of the preloaded software at a corresponding position of the planning file.

2. The method for subserving preloaded programs of claim 1 wherein the file which contains the installation flow data of the preloaded software is a file with ini extension.

3. The method for subserving preloaded programs of claim 1 wherein the step of increasing the number of the preloaded software comprises determining whether the preloaded software is a first preloaded software; if yes, then label it 1; if no, then increase the number by 1 according to a previous preloaded software.

4. The method for subserving preloaded programs of claim 1 wherein the step of storing the installation flow data of the preloaded software at the corresponding position of the planning file further comprises a step of storing a software name of the preloaded software.

5. The method for subserving preloaded programs of claim 4 wherein the software name is stored at a starting position of the planning file.

6. The method for subserving preloaded programs of claim 4 wherein the software name is stored at a starting position of the planning file according to the sequential number.

7. The method for subserving preloaded programs of claim 6 wherein the installation flow data of the preloaded software is stored under the software name sequentially.

8. The method for subserving preloaded programs of claim 1 wherein the method is executed with a file with bto extension.
